(19) United States
(12) Patent Application Publication
(10) Pub. No.: US 2013/0315117 A1
(43) Pub. Date: Nov. 28, 2013

(54) CONCURRENT-ACCESS DUAL-BAND TERMINAL OPERATING IN TWO ADJACENT BANDS

(71) Applicants: Jean-Yves Le Naour, Pace (FR); Jean-Luc Robert, Berton (FR); Dominique Lo Hine Tong, Rennes (FR); Ali Louzir, Rennes (FR)

(72) Inventors: Jean-Yves Le Naour, Pace (FR); Jean-Luc Robert, Berton (FR); Dominique Lo Hine Tong, Rennes (FR); Ali Louzir, Rennes (FR)

(73) Assignee: THOMSON LICENSING, Issy de Moulineaux (FR)

(21) Appl. No.: 13/984,063

(22) PCT Filed: Jan. 13, 2012
(86) PCT No.: PCT/FR12/50086

§ 371 Date: Aug. 7, 2013

(30) Foreign Application Priority Data
Feb. 10, 2011 (FR) 1151063

(51) Int. Cl. H04B 7/04

(52) U.S. Cl. CPC H04B 7/0404
USPC 370/297; 370/329

(57) ABSTRACT

The present invention relates to a terminal for the broadband transmission of video, audio or data signals in a domestic environment. It applies more specifically in the scope of terminals operating according to the standard IEEE 802.11n and employing simultaneously several frequency channels in a predetermined band of frequencies, for example the 5 GHz WiFi band. The terminal comprises M antennas, a MIMO device able to generate MIMO signals in said predetermined frequency band from baseband signals or conversely, said MEMO device being able to process N MIMO signals simultaneously, and a switching device to connect the MIMO device to the M antennas. According to the invention, the NINO device comprises two MIMO circuits, one operating in a first sub-band of the predetermined band and the other in a second sub-band of the predetermined band, the two sub bands being non-overlapping and the switching device is adapted to connect said two MIMO circuits to the antennas so that each of said M antennas is able to receive or transmit one of the MIMO signals of the first MIMO circuit and to receive or transmit one of the MIMO signals of the second MIMO circuit simultaneously. The switching device also comprises a filtering device associated with each antenna in order to isolate, in reception, the MIMO signal of the first sub-band of the MIMO signal from the second sub-band received or transmitted by said antenna.

### DOMAIN OF THE INVENTION

The present invention relates to a terminal for the high speed transmission of video, audio or data signals in a domestic environment. It applies more specifically in the framework of terminals operating according to the standard IEEE 802.11, and simultaneously employing several frequency channels.

### TECHNOLOGICAL BACKGROUND

WiFi technology in accordance with the standards IEEE 802.11a/b/g or 11 n is currently the most used technology for high speed wireless transmission in a domestic environment. The standard IEEE 802.11n provides some improvements with respect to IEEE 802.11a/b/g, Notably it authorises the use of MIMO (Multiple Input Multiple Output) technology which is a multi-antenna technique enabling improvement of the bitrate of transmissions and of their robustness in an environment, such as the domestic environment, that is dominated by interferences,

The standard IEEE 802.11n operates in the band 2.4 to 2.5 GHz and the band 4.9 to 5.9 GHz, These two bands are called 2.4 GHz band and 5 GHz band in the remainder of the description. Terminals exist that operate simultaneously in these two bands. The patent application FR 2 911 739 describes such a terminal. This is able to receive and/or transmit simultaneously a signal in a 2.4 GHz band and a signal in the 4.9 to 5.9 GHz band. The 5 GHz band is used for the transmission of video and the 2.4 GHz band is used for the transmission of data.

Though base stations exist that implement the splitting of a band into sub-bands each assigned to a user in the scope of 3G or 4G lo mobile telephony, as described in the patent application US 2010/0166098, there is currently no MIMO terminal that uses simultaneously two frequency channels in the 5 GHz band due to the frequency proximity of channels. More generally, there is currently no MIMO terminal functioning in the WiFi domain that is able to simultaneously transmit and/or receive signals contained in frequency channels that are very close.

### SUMMARY OF THE INVENTION

One purpose of the present invention is to propose a MIMO terminal that overcomes the drawback previously cited.

For this purpose, the present invention proposes a wireless communication terminal able to simultaneously transmit and/or receive video, audio or data signals in a predetermined frequency band, comprising:
a MIMO device able to generate N MIMO signals in said predetermined frequency band from n signals in baseband or to generate n signals in baseband from N MIMO signals in said predetermined frequency band, with N>n≧2,
M antennas to receive and/or transmit the N MIMO signals with M≧N/2, and
a switching device to connect the MIMO device to the M antennas,

characterized in that the MIMO device comprises a first MIMO circuit able to generate, from a baseband signal, N1 MIMO signals in a first sub-band of said predetermined frequency band or to generate, from N1 MIMO signals in said first sub-band, a baseband signal, and a second MIMO circuit able to generate, from a baseband signal, N2 MIMO signals in a second sub-band of said predetermined frequency band or to generate from N2 MIMO signals in said first sub-band, a baseband signal, with N1+N2=N, said first and second sub-bands being non-overlapping.

and in that the switching device comprises first and second channels adapted to connect said first and second MIMO channels to the antennas in such a way that each of said M antennas is able to receive or transmit one of the N1 MIMO signals of the first MIMO circuit and to receive or transmit one of the N2 MIMO signals of the second MIMO circuit simultaneously and also comprises a filtering device associated with each antenna and connected respectively to the first and the second channels in order to isolate the MIMO signal from the first sub-band of the MIMO signal of the second sub-band both received or transmitted by said antenna.

Thus, according to the invention, each antenna of the terminal is connected to two MIMO circuits operating in distinct sub-bands of the predetermined frequency sub-band and a filtering device is associated with each antenna to isolate the MIMO signal of the first sub-band from the MIMO signal of the second sub-band received or transmitted via the antenna.

According to a particular embodiment, the predetermined frequency band corresponds to the 5 GHz WiFi band. The first sub-band is the band [4.9 GHz, 5.35 GHz] and the second sub-band is the band [5.47 GHz, 5.875 GHz].

In a variant, the predetermined frequency band is a frequency band [790 MHz-862 MHz] of the digital dividend or is found in the UHF band [470 MHz-790 MHz].

According to a variant of the invention, the antennas are single access antennas and the filtering device is a diplexer.

According to a particular embodiment, the switching device is constituted of two switching circuits, one for the MIMO signals of the first sub-band and the other for the MIMO signals of the second sub-band. The switching device thus comprises first and second switching circuits to connect respectively the first and second MIMO circuits to the filtering device associated with each antenna.

Advantageously, the switching device also comprises a front-end module mounted between said first and second switching circuits and the filtering device associated with each antenna in order to amplify the MIMO signals from the antennas and/or the MIMO signals from the first and second MIMO circuits. Each front-end module comprises for example a low noise amplifier to amplify the MIMO signals intended for the first and second MIMO circuits and a power amplifier to amplify the MIMO signals intended for antennas. The role of these amplifiers is particularly to compensate at least in part for the signal losses introduced via filtering devices associated with the antennas and/or the switching circuits of the terminal.

Advantageously, the switching circuit also comprises N1 band-pass filters, mounted between the first MIMO circuit and the first switching circuit, each having a bandwidth noticeably corresponding to the first band-pass in order to filter MIMO signals intended for or coming from the first MIMO circuit and/or N2 band-pass filters, mounted between the second MIMO circuit and the second switching circuit, having a bandwidth noticeably corresponding to the second band-pass in order to filter the MIMO signals intended for or coming from the second MIMO circuit.

Preferably, the switching device also comprises amplification means mounted between the first and second MIMO circuits and the first and second switching circuits to amplify the MIMO signals coming from first and second MIMO circuits and amplification means mounted between the first and second MIMO circuits and the first and second switching circuits to amplify the MIMO signals coming from first and second switching circuits. The role of these amplification means is to compensate at least some of the signal losses introduced via band-pass filters.

According to a particular embodiment, the antennas of the terminal are directive antennas each covering a specific angular sector. The association of sectoring with MIMO techniques procures a significant gain in terms of coverage and performance in an environment where interferences are numerous, such as a domestic environment, Advantageously, the M antennas together cover an angular sector of 360°.

### BRIEF DESCRIPTION OF THE FIGURES

The invention will be better understood, and other aims, details, characteristics and advantages will appear more clearly over the course of the detailed description which follows in referring to the figures in the appendix, showing in:

FIG. 1, block diagram of a terminal in accordance with the invention,

FIG. 2 detailed block diagram of a basic block of the terminal of FIG. 1, and

FIG. 3, the partial block diagram of a terminal in accordance with the invention comprising two MIMO circuits 2*2 operating in two distinct sub-bands of a predetermined frequency band.

### DETAILED DESCRIPTION OF AN EMBODIMENT

The invention will be described in the scope of a terminal of a MIMO wireless transmission system operating in the 5 GHz WiFi band, said terminal being able to simultaneously transmit and/or receive at least 2 signals in this band.

The band of 5. Hz comprises two sub-bands, a first sub-band from 5.150 0Hz to 5.350 GHz, called the low sub-band, and a second sub-band from 5.470 GHz to 5,725 GHz for Europe, or from 5.470 GHz to 5.835 GHz for the United States, called the high sub-band. The two low and high sub-bands are close and separated by only 120 MHz, which requires the implementation of efficient radiofrequency filtering means in the transmission and reception channels of the terminal. Note that the power levels authorized in transmission in the 5 GHz band depend on the sub-band (low or high) and the region where the transmission system is deployed. The power authorized in transmission is higher in the United States than in Europe for some parts of the high sub-band and of the low sub-band.

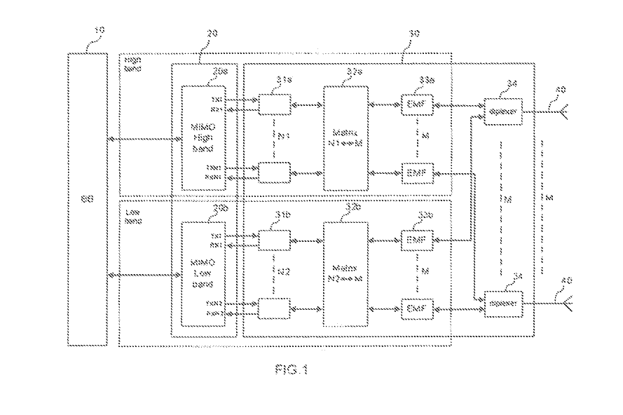

FIG. 1 shows the block diagram of a terminal in accordance with the invention able to simultaneously transmit and/or receive signals in the 5 GHz band. It comprises a digital processing circuit in baseband 10, a MIMO device 20 for generating MIMO signals in the 5 GHz frequency band from baseband signals delivered via the circuit 10 or for generating baseband from MIMO signals in the 5 GHz frequency band, a switching device 30 in order to connect the MIMO device 20 to M antennas 40, with M≧N where N represents the number of MIMO signals.

According to the invention, the MIMO device 20 is able to simultaneously process N MIMO signals and comprises two independent MIMO circuits, one 20a able to generate, from n signals in baseband, N1 MIMO signals in the high sub-band or inversely, the other MIMO circuit 20b able to generate, from signals in baseband, N2 MIMO signals in the low sub-band or inversely, N being the sum of N1 and N2 (N=N1+N2) and N>n≧2. In addition, each antenna 40 is able to simultaneously transmit or receive one of the N1 MIMO signals of the high sub-band and one of the N2 MIMO signals of the low sub-band.

In reference to FIG. 1, the MIMO circuit 20a comprises N1 input terminals RX1 to RXN1 to receive MIMO signals and N1 output terminals TX1 to TXN1 to transmit MINO signals. Likewise, the MIMO circuit 20b comprises N2 input terminals RX1 to AX N2 to receive MIMO signals and N2 output terminals TX1 to TXN2 to transmit MIMO signals. According to the invention, the switching device 30 is designed to selectively connect an input terminal or output of the MIMO circuit 20a (high sub-band) and an input terminal or output of the MIMO circuit 20b (low sub-band) to each antenna 40.

For this purpose, the switching device 30 comprises two switching matrixes, one 32a intended for MIMO signals of the high sub-band and the other 32b intended for MIMO signals of the low sub-band. The switching matrix 32a is connected to the input and output terminals of the MIMO circuit 20a via selectors 31a. A selector 31a is thus associated with each pair of terminals RXi TXi, i∈[1 . . . N1], to selectively connect the terminal RXi or the terminal TXi to the switching matrix 32a. Likewise, a selector 31b is associated with each pair of terminals RXj TXj, j∈[1 . . . N2], to selectively connect the terminal RXj or the terminal TXj to the switching matrix 32b.

The switching device also comprises a filtering device 34, mounted between the switching matrixes 32a, 32b and each of the antennas 40, to isolate the MIMO signal of the high sub-band from the MIMO signal of the low sub-band both of which are received or transmitted via the associated antenna. In the embodiment shown, the filtering device 34 is a dual access diplexer. Each diplexer is connected, via a switching matrix 32a or 32b and a selector 31a or 31b, to an input or output terminal of the MIMO circuit 20a (high sub-band) and an input or output terminal of the MIMO circuit 20b (low sub-band).

Advantageously, the switching device 30 comprises M front-end modules 33a connected between the switching matrix 32a and one of the diplexer 34 accesses and M front-end modules 33b connected between the switching matrix 32b and the other diplexer access in order to amplify the MIMO signals received and/or the MIMO signals to be transmitted via the terminal. Thus, according to the invention, each diplexer 34 is connected to a front-end module 33a and a front-end module 33b.

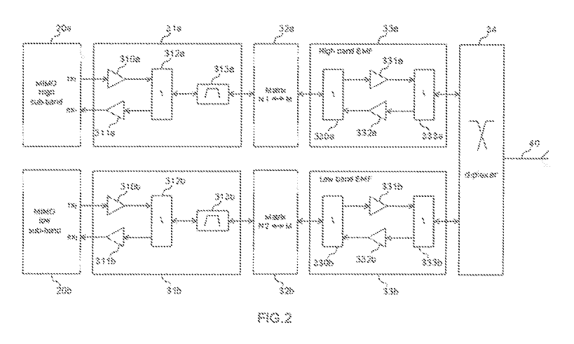

The selectors 31a and 31b and the front-end modules 33a and 33b will be described in more detail in reference to FIG. 2 which represents a basic block of the terminal of FIG. 1. This latter comprises M basic blocks each associated with one of the M antennas 40. This basic block comprises all the circuits intervening in the processing of MIMO signals received or transmitted by the associated antenna.

Each basic block thus comprises a diplexer connected to the antenna 40 of the basic block. The diplexer 34 is connected by one of its accesses to the MIMO circuit 20a (high sub-band) via a selector 31a, the switching matrix 32a and a front-end module 33a and by the other of its access to the MIMO circuit 20b (low sub-band) via a selector 31b, the switching matrix 32b and a front-end module 33b.

The front-end module 33a comprises a low noise amplifier 332a to amplify the MIMO signals of the high sub-band received by the antenna 40 and a power amplifier 331a to amplify the MIMO signals of the high sub-band to be transmitted. These amplifiers are connected, via a first SPDT (Single Pole Double Throw) switch referenced as 330a, to the switching matrix 32a and, via a second SPDT switch referenced 333a, to the high sub-band access of the diplexer 41.

Likewise, the front-end module 33b comprises a low noise amplifier 332b to amplify the MIMO signals of the low sub-band received by the antenna 40 and a power amplifier 331b to amplify the MIMO signals of the low sub-band to be transmitted. These amplifiers are connected, via a SPDT switch 330b, to the switching matrix 32b and, via a SPDT switch 333b, to the low sub-band access of the diplexer 34.

The role of the amplifiers 331a and 331b is to compensate at least in part for the signal losses introduced by the switching matrix 32a or 32b and the switch 330a or 330b. The role of the amplifiers 332a and 332b is to compensate at least in part for the signal losses introduced by the filtering device 34 and the switch 333a or 333b.

The high and low sub-bands being relatively close (120 MHz between the last channel of the low sub-band and the first channel of the high sub-band), the amplifiers 331a and 331b are noticeably identical. Likewise, the amplifiers 332a and 332b are noticeably identical.

The front-end modules are placed between the switching circuits and the filtering devices of antennas in order to compensate for losses introduced by these elements, which enables the power to be delivered by the power amplifiers 331a and 331b to be minimised and the sensitivity of the terminal in reception to be increased. This also results in the reduction in consumption and thermal dissipation of the terminal set.

On the other side of the switching matrix 32a, the selector 31a comprises a SPDT switch 312a to select the terminal TXi or the terminal RXi of the MIMO circuit 20a and connect it to the switching matrix 32a. The selector 31a advantageously comprises a band-pass filter 313a having a bandwidth noticeably corresponding to the high sub-band. The filter 313a is mounted between the switch 312a and the switching matrix 32a, The selector 31a also comprises a power amplifier 310a mounted between the terminal TXi of the MIMO circuit 20a and the SPDT switch 312a as well as a low noise amplifier 311a mounted between the terminal RXi of the circuit 20a and the SPDT switch 312a to compensate at least in part for the losses in signal introduced via the band-pass filter 313a. An identical circuit for the selector 31b is provided on the other side of the switching matrix 32b, this circuit comprising a SPDT switch 312b, a band-pass filter 313b and two amplifiers 310b and 311b, the set being mounted as described above for the selector 31b.

The high and low sub-bands being relatively dose (120 MHz between the last channel of the low sub-band and the first channel of the high sub-band), the simultaneous and independent functioning of the terminal over two distinct channels (one channel in the low sub-band and one channel in the high sub-band) results in filtering constraints on one hand at the level of filters of the diplexer 34 and on the other hand at the level of band-pass filters 313a and 313b.

Filtering constraints at the level of the filter 34 are defined by the noise outside of the useful channel generated by the amplifier 331a (respectively 331b) on the high sub-band access (respectively low sub-band) of the diplexer and the reception threshold on the low sub-band access (respectively high sub-band). In a first approximation, if it is considered that the amplifier 331 a is noticeably identical to the amplifier 331 b and that the amplifier 332a is noticeably identical to the amplifier 332b, the isolation required between the access to the high sub-band and the access to the low sub-band of the diplexer, noted as ISO_DIPL, must be the following:

ISO_{—}DIPL=NF_{—}PA+Gain_{—}PA−NF_{—}LNA+MARGE

where:
NF_PA is the noise factor of amplifiers 331a and 331b;
Gain_PA is the gain of amplifiers 331a and 331b,

NF_LNA is the noise factor of amplifiers 332a and 332b, and
MARGE is a margin of security.

If, for example, the amplifiers 331a, 331b, 332a and 332b are considered with the following characteristics NF_PA=10 dB, Gain_PA=30 dB, NF_LNA=5 dB and a margin of 5 dB, the isolation required at the level of the two diplexer accesses 34 is 40 dB.

Likewise, the additional filtering constraints at the level of filters 313a and 313b are defined by the noise outside the useful band of the MIMO signal generated by the MIMO circuit 20a (or 20b) for the transmission and protection necessary in reception of the MIMO circuit 20b (or 20a) in order to not degrade the performance of the terminal during a transmission. The rejection required is mainly determined by the stray emission outside of the useful channel of the MIMO circuits, In a first approximation this required rejection ‘REJECTION’ is defined by the following expression:

REJECTION=NF_MIMO−NF_{—}PA′+MARGE

where:
NF_MIMO is the apparent noise factor of MIMO circuits 20a and 20b,
NF_PA is the noise factor of amplifiers 310a and 310b,
MARGE is an additional margin of security.

If, the amplifiers 310a, 310b and the MIMO circuits 20a and 20b are considered with the following characteristics: NF_MIMO=41 dB, NF_PA′=10 dB and a margin of 5 dB, the rejection required for the two filters 313a and 313b is 36 dB

This terminal can be employed with directive antennas each covering a specific angular sector. Preferably, the M antennas cover the whole of a complete angular sector of 360°, the angular sectors of antennas being overlapping or non-overlapping. The angular sector associated with each antenna intervenes then in the selection process of antennas operated by the switching device.

In the case of a transmission of data and video signals, the low sub-band is advantageously used for the transmission of data and the high sub-band is used for the transmission of video signals.

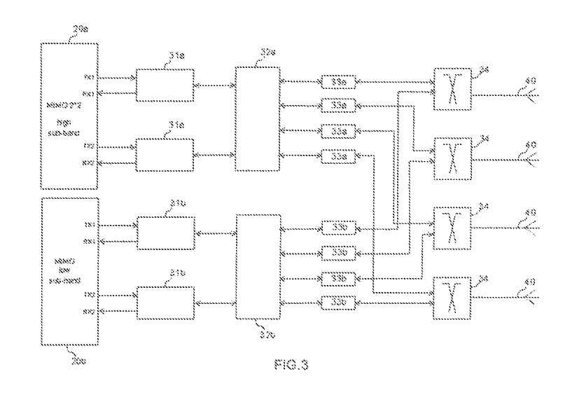

FIG. 3 gives an example of a terminal in accordance with the invention comprising two MIMO circuits 2*2. In this figure, the elements that are identical to the elements of the schemas of FIGS. 1 and 2 have the same references. The terminal of FIG. 3 comprises two MIMO circuits 2*2, one 20a operating in the high sub-band and the other 20b operating in the low sub-band, connected to 4 antennas 40, directive or not, via a switching device comprising two selectors 31a, two selectors 31b, the two switching matrixes 32a and 32b, four front-end modules 33a, four front-end modules 33b and four diplexers 34. In this example, there is thus N1=4, N2=4, N=N1+N2=8 and M=4. Each antenna 40 transmits or receives a MIMO signal in the high sub-band and a MIMO signal in the low sub-band.

Though the invention has been described in relation to a specific embodiment, it is evident that this is in no way restricted and that it comprises all technical equivalents of the means described as well as their combinations if these enter into the scope of the invention.

In the embodiment shown, the diplexer is dual-access and the antennas are mono-access. These latter cover the two sub-bands high and low. This assembly can be replaced by dual-access antennas having good isolation between their accesses and independent filters mounted on each access.

In the embodiment shown, the filters 313a and 31b are placed between the NANO circuits and the switching circuits. It may be considered to place them elsewhere, for example between the switching matrixes and the SPOT switches 330a, 330b.

Finally, in the scope of deployment of broadband multimedia networks in a domestic environment, the particular architectural concept of the user terminal proposed here enables dual-band MIMO WiFi solutions to be implemented in the sought after 5 GHz band associated or not with directive antennas. This concept enables a simultaneous and independent transmission over at least two channels in the 5 GHz band. This concept can be extended into a frequency band such as for example the liberated UHF band corresponding to the digital dividend.

1) A wireless communication terminal able to simultaneously transmit and/or receive signals in a predetermined band of frequencies, comprising:
a MIMO device able to generate N MIMO signals in said predetermined frequency band from n signals in baseband or to generate n signals in baseband from N MIMO signals in said predetermined frequency band, with N>n≧2,
M antennas to receive and/or transmit the N MIMO signals with M≧N/2, and
a switching device to connect the NINO device to the M antennas,
characterized in that the MIMO device comprises a first MIMO circuit able to generate, from a baseband signal, N1 MIMO signals in a first sub-band of said predetermined frequency band or to generate, from N1 MIMO signals in said first sub-band, a baseband signal, and a second MIMO circuit able to generate, from a baseband signal, N2 MIMO signals in a second sub-band of said predetermined frequency band or to generate from N2 MIMO signals in said first sub-band, a baseband signal, with N1+N2=N, said first and second sub-bands being non-overlapping,
and in that the switching device comprises first and second channels adapted to connect said first and second MIMO channels to the antennas in such a way that each of said M antennas is able to receive or transmit one of the N1 MIMO signals of the first MIMO circuit and to receive or transmit one of the N2 MIMO signals of the second MIMO circuit simultaneously and also comprises a filtering device associated with each antenna comprising the first and the second channels in order to isolate the MIMO signal from the first sub-band of the MIMO signal of the second sub-band both received or transmitted by said antenna.

2) The terminal according to claim 1, wherein the predetermined frequency band corresponds to the 5 GHz WiFi band.

3) The terminal according to claim 2, wherein the first sub-band is the band [4.9 GHz, 5.35 GHz] and the second sub-band is the band [5.47 GHz, 5.875 GHz].

4) The terminal according to claim 1 wherein the antennas are single access antennas and the filtering device associated with each antenna is a diplexer

5) The terminal according to claim 1 wherein the switching device comprises first and second switching circuits in order to connect respectively the first and second MIMO circuits to the filtering device associated with each antenna.

6) The terminal according to claim 5 wherein the switching device also comprises a front-end module mounted between said first and second switching circuits and the filtering device associated with each antenna in order to amplify the MIMO signals from the antennas and/or the MIMO signals from the first and second MIMO circuits.

7) The terminal according to claim 5 wherein the switching circuit also comprises N1 band-pass filters, mounted between the first MIMO circuit and the first switching circuit, each having a bandwidth noticeably corresponding to the first band-pass in order to filter MIMO signals intended for or coming from the first MIMO circuit and/or N2 band-pass filters, mounted between the second MIMO circuit and the second switching circuit, having a bandwidth noticeably corresponding to the second band-pass in order to filter the MIMO signals intended for or coming from the second MIMO circuit.

8) The terminal according to claim 5 wherein the switching device also comprises amplification means mounted between the first and second MIMO circuits and the first and second switching circuits to amplify the MIMO signals coming from first and second NINO circuits.

9) The terminal according to claim 5 wherein the switching device also comprises amplification means mounted between the first and second MIMO circuits and the first and second switching circuits to amplify the MIMO signals coming from first and second switching circuits

10) The terminal according to claim 1 wherein the antennas are directive antennas each covering a specific angular sector, the M antennas together covering preferably a 360° angular sector.
